(19) United States
(12) Patent Application Publication
(10) Pub. No.: US 2019/0225071 A1
(43) Pub. Date: Jul. 25, 2019

(54) UTILITY VEHICLE AND METHOD FOR OPERATING THE UTILITY VEHICLE

(71) Applicant: Rosenbauer International AG, Leonding (AT)

(72) Inventors: Anton KLUCSARITS, Kleinzell i.M (AT); Edmund PENZ, Linz (AT); Alexander RONACHER, Hoersching (AT); Stefan ZAUNER, St. Martin i.M. (AT)

(73) Assignee: Rosenbauer International AG, Leonding (AT)

(21) Appl. No.: 16/332,490

(22) PCT Filed: Sep. 8, 2017
(86) PCT No.: PCT/AT2017/060219

§ 371 Date: Mar. 12, 2019

(30) Foreign Application Priority Data
Sep. 13, 2016 (AT) A 50813/2016

(51) Int. Cl. B60K 6/40; B60K 5/10; B60K 6/387; B60K 25/00; B60K 6/36

(52) U.S. Cl. CPC B60K 6/40; B60K 5/10; B60K 6/387; B60Y 2400/204; B60K 6/36; B60Y 2200/14; B60Y 2200/92; B60K 25/00

(57) ABSTRACT

The invention relates to an emergency vehicle (1), especially fire truck, comprising:
a vehicle body (2);
at least two wheel pairs (3) having respectively at least two wheels (6), which are disposed on the vehicle body (2);
an accumulator (10) for storage of electrical energy;
a secondary energy unit (7) for conversion of an energy stored in a fuel into electrical energy;
at least one electric motor (11).

The secondary energy unit (7) is disposed on a carrier frame (14), wherein the carrier frame (14) is received in modular and detachable manner on the vehicle body (2).

The invention relates to an emergency vehicle, especially fire truck.

From WO 2014/043734 A2, a voltage-supply and drive system is known for a fire truck or rescue vehicle or special utility vehicle having at least one drive source and having several voltage sources, which are connected to one another via an electric wiring network, and a control device. At least one of the voltage sources is formed by a battery. The control device is designed for closing and opening of the circuit of one or more voltage sources and/or one or more drive sources with due consideration for at least one emission value of at least one of the voltage sources and/or at least one of the drive sources. Thereby the voltage and/or drive sources integrated in the voltage-supply and drive system of the fire truck and rescue vehicle or special utility vehicle may be operated in combined manner in such a way that a minimum total emission value can be achieved.

The task of the present invention was to provide an improved emergency vehicle having improved drive system.

This task is accomplished by an apparatus and a method according to the claims.

According to the invention, an emergency vehicle, especially fire truck is designed. The emergency vehicle comprises:

a vehicle body;
at least two wheel pairs having respectively at least two wheels, which are disposed on the vehicle body;
a primary energy unit, especially an accumulator, for storage of electrical energy;
a secondary energy unit for conversion of an energy stored in a fuel into electrical energy;
at least one electric motor.

The secondary energy unit is disposed on a carrier frame, wherein the carrier frame is received in modular and detachable manner on the vehicle body.

It is of advantage in the construction of the emergency vehicle according to the invention that, due to the modular structure of the carrier frame and of the arrangement of the secondary energy unit on the carrier frame, the maintenance of the emergency vehicle may be facilitated. In particular, the carrier frame together with the secondary energy unit may be lifted out of the emergency vehicle, in order to make them easily accessible for the performance of important repair tasks. Beyond this, the secondary energy unit together with the carrier frame may be easily replaced by a further carrier frame having a further secondary energy unit, for example for maintenance or repair. Thereby, in case of a defect in the secondary energy unit, the emergency vehicle is non-operational only for the brief time of the replacement of the secondary energy units. In this way, the emergency-readiness duration can be improved compared with a conventionally designed emergency vehicle. This is the case in particular in very extensive districts, in which the emergency vehicle would have to be repaired locally, since, for example, the demounted secondary energy unit can be transported more easily to a workshop some distance away.

Furthermore, it may be expedient when that the secondary energy unit is designed in the form of a galvanic cell. It is of advantage that, in galvanic cells, the energy stored in the fuel can be converted directly into electrical energy in a chemical reaction.

Alternatively to this, it may be provided that the secondary energy unit is designed in the form of an internal combustion engine, especially a diesel engine, wherein the internal combustion engine is coupled with a generator. It is then of advantage that a diesel engine can be used as the secondary energy unit, which is robustly structured and beyond this can have good efficiency. This internal combustion engine may be torque-coupled with a generator for generation of electrical current, wherein the rotary motion of a power take-off shaft of the internal combustion engine is transmitted to the generator.

Furthermore, it may be provided that at least one consuming unit, especially an emergency machine such as a pump, is disposed on the emergency vehicle, wherein the at least one consuming unit is torque-coupled with the secondary energy unit, optionally via interposition of a gearbox. It is then of advantage that the consuming unit can be driven by the secondary energy unit, for example the internal combustion engine. It is then conceivable that the generator is interposed between the secondary energy unit and the consuming unit, wherein the generator may optionally have a continuous shaft, to which the consuming unit is coupled.

Beyond this, it may be provided that a first shiftable clutch is interposed between the internal combustion engine and the generator. It is then of advantage that the mechanical torque coupling between internal combustion engine and generator may be separated by this feature.

A manifestation is also advantageous according to which it may be provided that a second shiftable clutch is interposed between the generator and the at least one consuming unit, especially the pump. It is then of advantage that the torque communication between the consuming unit and the generator may be separated by this feature. Thereby the generator can be driven by the internal combustion engine even though the consuming unit is not being jointly driven simultaneously.

According to a further development, it is possible that the generator can be used while the internal combustion engine is stationary, optionally for operation as an electric motor and thus for the drive of the consuming unit, wherein the first shiftable clutch is decoupled between the generator and the internal combustion engine, or wherein a freewheel is disposed between the generator and the internal combustion engine. It is then of advantage that an operation of the consuming unit purely by the driving force of the generator is possible due to this feature and thus without simultaneous operation of the internal combustion engine. Thereby the consuming unit may be operated in environmentally friendly and quiet manner. By use of the generator and operation of it as an electric motor, additionally needed drives and thereby costs may be saved.

Furthermore, it may be expedient when the primary energy unit and the secondary energy unit are additively connectable by means of an electronic control unit, so that the power of the primary energy unit and also the power of the secondary energy unit can be fed simultaneously to the electric motor. It is then of advantage that the electric motor can be supplied with additional energy by this feature. This may be necessary, for example, when the highest possible power is demanded from the electric motor in a so-called power mode, as is the case, for example, for the acceleration of extinguishing-agent-transporting fire trucks at airports.

Beyond this, it may be provided that the at least one consuming unit, especially the pump, is likewise disposed on a carrier frame. It is then of advantage that the structural parts of the consuming unit and of the secondary energy unit coupled mechanically with one another can be lifted together out of the emergency vehicle, in order that the carrier frame and the structural parts received thereon can be removed from the emergency vehicle with the least possible effort.

Furthermore, it may be provided that the secondary energy unit is disposed above the at least one consuming unit on the carrier frame. It is then of advantage that the consuming unit is thereby as easily accessible as possible to the operating personnel based on the ground and therefore the operating comfort can be increased by this feature.

According to a particular manifestation, it is possible that the secondary energy unit and the at least one consuming unit are coupled to one another by means of an angular gearbox. It is then of advantage that such an angular gearbox can be designed as robustly as possible and in this way is highly suitable for torque transmission between secondary energy unit and the consuming unit. Beyond this, by means of the angular gearbox, the torque can be transmitted from a horizontally oriented motor shaft to a vertically oriented drive shaft of the consuming unit.

According to an advantageous further development, it may be provided that the carrier frame is disposed in the region of the rear-wheel pair, above it. Thereby the carrier frame may be received on the emergency vehicle in the most space-saving manner possible, wherein the individual units disposed on the carrier frame are as readily accessible as possible. Moreover, the distribution of the center of gravity of the emergency vehicle can be configured as well as possible by this feature, in order to achieve a stable highway situation.

In particular, it may be advantageous when the carrier frame has a lifting eye, by means of which lifting eye the carrier frame can be lifted away from the vehicle body. Thereby the carrier frame has a fixed receiving point, whereby it can be prevented as well as possible that the carrier frame does not become connected to a lifting means at a position unsuitable for the purpose.

Furthermore, it may be provided that the electric motor is designed as a drive motor for at least one of the wheels. It is then of advantage that the emergency vehicle can be driven by electromotive power and thereby the electrical energy supplied in the secondary energy unit and/or the primary energy unit may be used for the drive of the emergency vehicle.

Beyond this, it may be provided that the wheels at least of one of the wheel pairs are torque-coupled with one another by means of a differential and that the electric motor, as the central drive of the two wheels, is coupled with the differential. It is then of advantage that a central electric motor can be used for the drive of the wheel pair and that an equalization of the torque transmitted by the electric motor to the wheels can be achieved by the differential. Beyond this, costs may be saved by such a structure, for example in comparison to two built-in wheel-hub motors. Also, the distribution of center of gravity of a drive system designed according to the invention is better than during the use of wheel-hub motors.

A manifestation is also advantageous according to which it may be provided that the electric motor is coupled by means of a gearbox with the differential and that a secondary output for the drive of further units is formed on the gearbox, wherein optionally the differential and/or the secondary output can be driven by the electric motor by means of the gearbox. Thereby a separate drive for the drive of further units may be saved. In particular, it may be provided in this connection that the secondary output and the differential are driven simultaneously by the electric motor.

In a further extended development variant, it may also be provided that the gearbox may be shifted in such a way that the secondary output and/or the differential can be driven selectively by means of the electric motor.

Furthermore, it may be provided that an energy-input interface is formed, by means of which electrical energy can be drawn from an external energy-supplying apparatus, such as, for example, a further emergency vehicle. Thereby it may be achieved that the emergency vehicle is able to fulfill its emergency purpose and remain mobile despite failure of one of the energy sources or in the case of too little energy generation by the energy sources.

Furthermore, it may be provided that an energy-output interface is formed, by means of which electrical energy can be delivered to an external energy-drawing source, such as, for example, a further emergency vehicle. Thereby surplus energy can be made available to a further emergency vehicle and thus support can be provided, in order to increase the failure safety of the emergency vehicle and to avoid an interruption of the emergency operation of the emergency vehicle as much as possible.

According to a further development, it is possible that a second electric motor is coupled with the differential, wherein the second electric motor cooperates in modular manner with the first electric motor. It is then of advantage that, for example, only one electric motor can be used in a first configuration and such an emergency vehicle therefore has a smaller drive power, and that, by only small reconstruction steps into a second configuration, both electric motors together may be used for the drive of the emergency vehicle, so that the emergency vehicle then has a higher drive power.

Beyond this, according to the invention, a method is provided for operation of an emergency vehicle. In a power mode, the electrical energy generated by the secondary energy unit and additively therewith the electrical energy stored in the primary energy unit is used for the drive of the electric motor.

It is then of advantage that thereby an increased energy quantity is available to the electric motor. This may then be particularly advantageous when the emergency vehicle must accelerate to a high speed, for example, within the shortest possible time as is the case, for example, during operation at an airport.

For better understanding of the invention, it will be explained in more detail on the basis of the following figures.

Therein, respectively in greatly simplified schematic diagrams:

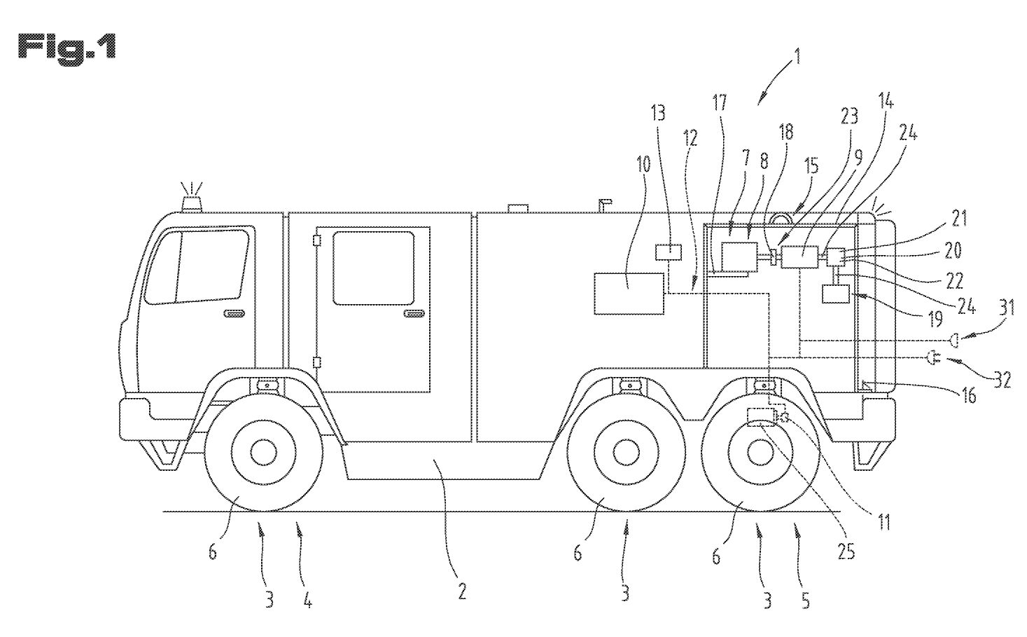

FIG. 1 shows a side view of a schematically illustrated emergency vehicle;

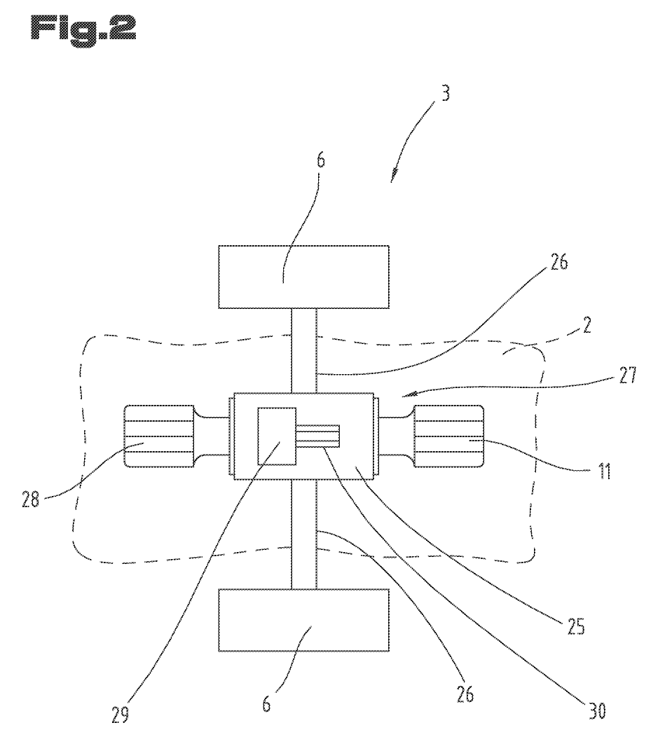

FIG. 2 shows an overhead view of a schematically illustrated wheel pair of an emergency vehicle.

By way of introduction, it is pointed out that like parts in the differently described embodiments are denoted with like reference symbols or like structural part designations, wherein the disclosures contained in the entire description can be carried over logically to like parts with like reference symbols or like structural-part designations. The position indications chosen in the description, such as top, bottom, side, etc., for example, are also relative to the figure being directly described as well as illustrated, and these position indications are to be logically carried over to the new position upon a position change.

In FIG. 1, an emergency vehicle 1 is illustrated in a schematic side view.

The emergency vehicle 1 may be used for the most diverse emergency purposes, especially as a fire truck, public works vehicle, special vehicle or transportation vehicle.

In one embodiment variant, it may be provided that the emergency vehicle 1 is designed as an extinguishing-agent-transporting fire truck for airport operations.

In a further embodiment variant, it may be provided that the emergency vehicle 1 comprises a turntable ladder.

In yet another embodiment variant, it may be provided that the emergency vehicle 1 is designed as a hoisting-machine platform.

At least two wheel pair 3, especially at least one front-wheel pair 4 and at least one rear-wheel pair 5 are held or mounted on a vehicle body 2. Each of the wheel pairs 3 has at least two wheels 6. Instead of individual wheels, it would even be possible to use dual wheels as well. For the sake of better clarity, the illustration of a drive unit or other units or components of structural parts has not been presented.

The vehicle body 2 of the emergency vehicle 1 may be designed as a self-supporting body or even as a non-self-supporting body. Here it will be understood as any structure designed among other purposes to carry the individual wheel pairs 3, the drive elements and many other components. In particular, it may be provided that the vehicle body 2 comprises a core tube. The core tube may extend in longitudinal direction, centrally relative to the vehicle body 2. Furthermore, it may be provided that body parts are disposed on this core tube.

In the exemplary embodiment shown here, one possible form of an emergency vehicle is illustrated as a fire truck. The most diverse storage compartments and/or storage boxes may be provided on the vehicle body 2, so that the equipment items, tools and much more necessary for emergency operations can be carried along in orderly manner. Furthermore, drive units and/or additional aggregates of the emergency vehicle 1 may be disposed on the vehicle body 2.

In particular, it may be provided that the emergency vehicle 1 has a secondary energy unit 7, which is designed for conversion of an energy stored in a fuel into electrical energy. The secondary energy unit 7 may be constructed, for example, in the form of an internal combustion machine, especially an internal combustion engine 8, which is torque-coupled with a generator 9. A liquid or gaseous fuel may be burned in the internal combustion engine 8, and thereby the energy stored in the fuel may be fed to the generator 9 and converted therein into electrical energy.

Preferably, diesel is used as the fuel for operations in an emergency vehicle 1, wherein the internal combustion engine 8 is referred to in this case as a diesel engine. In particular, it is provided that the generator 9 is torque-coupled with a power take-off shaft of the internal combustion engine 8.

In another embodiment variant, the internal combustion engine 8 may also be operated, for example, with gasoline, methane, hydrogen, ethanol or another motor fuel.

In a preferred embodiment variant, the internal combustion engine 8 is designed as a piston engine or, for example, in the form of a rotary-piston engine, especially Wankel engine. In further embodiment variants, however, it is also conceivable that the internal combustion machine is designed in the form, for example, of a turbine.

Beyond this, it is also conceivable that the secondary energy unit 7 is designed in such a way that the electrical energy can be extracted from the fuel by other chemical reactions. Such a secondary energy unit 7 may be constructed in the form, for example, of a galvanic cell, such as, for example, a fuel cell or a flow cell. Beyond this, it is also conceivable that the secondary energy unit 7 is designed in the form, for example, of a photovoltaic cell, for conversion of solar energy into electrical energy.

Furthermore, the emergency vehicle 1 comprises a primary energy unit 10, especially an accumulator, which is designed for storage of electrical energy. For example, the most diverse accumulators on the basis of lithium, sodium, nickel, lead or another basis may be provided. Furthermore, it is also conceivable that, for example, a capacitor is designed as the primary energy unit 10.

Furthermore, an electric motor 11 is provided that converts the electrical energy back to mechanical energy, especially to a rotary motion of a drive shaft of the electric motor, and is used for the drive of a consumer. In particular, it may be provided that the electric motor 11 is designed as a drive motor for the drive of the emergency vehicle 1. The exact structure of the drive unit will be described in still more detail further on, especially in FIG. 2.

The primary energy unit 10 may be charged, for example by the generator 9. Furthermore, it is also conceivable that the primary energy unit 10 is charged by recovery of energy from braking energy in the electric motor 11.

The secondary energy unit 7 and the primary energy unit 10 may be disposed in interior regions of the emergency vehicle 1. Thereby the outer regions of the emergency vehicle 1, which are easily reachable by firefighting personnel, are outfitted with those aggregates that must be readily accessible in the emergency situation.

Furthermore, an electrical wiring network 12 is constructed, which is used to transmit the electrical energy between secondary energy unit 7, primary energy unit 10 and electric motor 11. Beyond this, an electronic control unit 13 is provided, by means of which the energy flow of electrical energy can be controlled and monitored in the electrical wiring network.

In particular, various modes of operation, in which the secondary energy unit 7, the primary energy unit 10 and the electric motor 11 interact differently, may be realized by the electronic control unit 13.

For example, it may be provided that the secondary energy unit 7 delivers precisely as much energy at a given instant as is needed in the electric motor 11 or in further consumers. In the primary energy unit 10, therefore, neither is energy injected into nor is energy drawn out of it.

Furthermore, it is also conceivable that the secondary energy unit 7 supplies more energy than is needed in the electric motor 11 or in the further consumers and that this surplus energy is stored temporarily in the primary energy unit 10.

In yet another mode of operation, it is also possible that more energy is needed in the electric motor 11 or in the further consumers than can be supplied in the secondary energy unit 7 and that this additional energy is fed from the primary energy unit 10.

In yet another mode of operation, it is also conceivable that neither the electric motor 11 nor a further consumer needs energy, and that the energy generated in the secondary energy unit 7 is stored temporarily in the primary energy unit 10.

In yet another mode of operation, it is also possible that the secondary energy unit 7 is not activated and that the electrical energy needed by the electric motor 11 or the further consumers is drawn in its entirety from the primary energy unit 10.

In particular, it may be achieved by the described configuration of the electronic control unit 13 that, for example, the secondary energy unit 7 can be operated in a power range having good efficiency, and that the different requirements applicable to the energy supply by the primary energy unit 10 are balanced out.

Especially for multifunctional emergency vehicles 1, it may be provided that several different consumer units are formed that fulfill different purposes. These may be, for example, diverse water pumps, hydraulic aggregates or even generators.

Furthermore, it may be provided that a carrier frame 14, in which the secondary energy unit 7 is contained, is disposed on the emergency vehicle 1. By means of the carrier frame 14, the secondary energy unit 7 may be lifted easily out of the emergency vehicle 1. For this purpose, at least one lifting eye 15 may be formed, which is disposed on the carrier frame 14.

Furthermore, it may be provided that the carrier frame 14 is coupled with the vehicle body 2, with use of fastening means 16, especially with use of screws. Carrying struts 17 of the most diverse kind, on which the individual elements and aggregates received in the carrier frame 14 may be disposed, may be formed in the carrier frame 14.

For the use of the internal combustion engine 8 as the secondary energy unit 7, it may be provided, for example, that both the internal combustion engine 8 and the generator 9 are received on the carrier frame 14.

Furthermore, it may be provided that a first shiftable clutch 18, which is used for the separation or establishment of the mechanical communication, especially of the torque communication between internal combustion engine 8 and generator 9, is formed between the intern combustion engine 8 and the generator 9.

Furthermore, a gearbox arrangement may be formed between internal combustion engine 8 and generator 9.

Beyond this, the emergency vehicle 1 may be provided with a consuming unit 19, which likewise may be coupled with the internal combustion engine 8 or with the generator 9. In particular, it may be provided that the consuming unit 19 is constructed in the form of a pump, which may be used, for example, for the pumping of extinguishing water.

The consuming unit 19 may likewise be received on the carrier frame 14. In particular, it is conceivable that the consuming unit 19 is disposed on a plane underneath the internal combustion engine 8. Stated in other words, the internal combustion engine 8 may be situated higher than the consuming unit 19.

Furthermore, it may be provided that a gearbox 20 is disposed between the consuming unit 19 and the generator 9, in order to be able to achieve the needed rpm or the needed torque at the consuming unit 19.

Furthermore, it may be provided that an angular gearbox 21 is formed between the consuming unit 19 and the generator 9. The angular gearbox 21 may be used for transmission of the mechanical energy, especially of the rotary motion, from the generator 9 to the consuming unit 19.

Furthermore, it may be provided that a second shiftable clutch 22 is disposed between the generator 9 and the consuming unit 19, by means of which the torque transmission between these two components can be interrupted. In particular, it may be provided that the shiftable clutch 22 is formed in a common housing together with the angular gearbox 21. The angular gearbox 21 may likewise be fastened on the carrier frame 14.

Furthermore, as an alternative or in addition to the first shiftable clutch 18, a freewheel 23 may be formed between the internal combustion engine 8 and the generator 9. Due to the freewheel 23, it may be achieved that the generator 9, during operation of the internal combustion engine 8, is driven by this. However, when the generator 9 is functioning as an electric motor and is driving the consuming unit 19, the internal combustion engine 8 may be stationary.

The individual structural parts, such as internal combustion engine 8, generator 9 and consuming unit 19 are coupled with one another by means of drive shafts 24.

Besides the already described components, it may also be provided that further add-on parts or components of the emergency vehicle 1 are disposed on the carrier frame 14. Preferably, the carrier frame 14 is coupled in modular manner with the vehicle body 2, so that it may be easily extracted from the emergency vehicle 1 for maintenance purposes or for repair purposes.

Furthermore, it may be provided that one or more plug connections are formed in the electrical wiring network 12, by means of which the electrical units built into the carrier frame 14, such as the generator 9, for example, may be easily unplugged during demounting of the carrier frame 14.

In particular, it is conceivable that the carrier frame 14, by loosening of the fastening means 16 and by separation of the electrical wiring network 12, may be easily lifted out of the emergency vehicle 1. In the process, the structural parts disposed on the carrier frame 14 may be lifted out of the emergency vehicle 1 together with the carrier frame 14.

After this process, the carrier frame 14 or the components attached to it may be maintained or repaired outside the emergency vehicle 1.

In FIG. 2, the wheel pair 3 used for the drive of the emergency vehicle 1 is illustrated in an exemplary overhead view. In a first embodiment, it is possible that only one driven wheel pair 3 is built in on the emergency vehicle 1. Furthermore, it is also conceivable that several or all wheel pairs 3 of the emergency vehicle 1 have a drive function. In total, at least two wheel pairs 3 are built into the emergency vehicle 1.

The wheels 6 of the wheel pair 3 may also be optionally designed as steerable.

Beyond this, the wheels 6 of the wheel pair 3 are coupled with the vehicle body 2, wherein, for the sake of clarity, this is illustrated only schematically.

In a first embodiment variant, it may be provided that the wheels 6 are coupled with the vehicle body 2 by means of an individual wheel suspension.

In a further embodiment variant, it may also be provided that the wheels 6 are disposed on a common axle, which is received on the vehicle body 2.

Furthermore, an energy-input interface 31 may be formed, by means of which electrical energy can be drawn from an external energy-supplying apparatus, such as, for example, a further emergency vehicle. Such an external energy-supplying apparatus may also be, for example, a mobile energy-supplying source, such as, for example, an internal combustion machine together with generator or a galvanic cell.

Moreover, an energy-output interface 32 may be formed, by means of which electrical energy can be delivered to an external energy-drawing source, such as, for example, a further emergency vehicle. The external energy-drawing source may also be, for example, a machine that does not have any drive unit of its own, for example a pump being transported on a trailer.

As is evident from FIG. 2, it may be provided that the electric motor 11 is coupled with a differential 25, and the drive wheels 6 are torque-coupled with the differential 25 via two half axles 26. Furthermore, it may be provided that a gearbox 27 is disposed between electric motor 11 and the differential 25, by means of which the rpm of the electric motor 11 may be appropriately stepped down. Alternatively, the gearbox 27 may also be formed directly on the electric motor 11, for example in the form of a gear motor. In a further alternative variant, it may also be provided that the gearbox 27 is disposed together with the differential 25 in a common casing.

Furthermore, it may be provided that a second electric motor 28 is formed, which may likewise be coupled to the differential 25.

Furthermore, it is also conceivable that a secondary output 29, which has a power take-off shaft 30, is disposed on the differential 25 or on the gearbox 27. The secondary output 29 may be used for the drive of further consuming units.

The exemplary embodiments show possible embodiment variants, wherein it must be noted at this place that the invention is not restricted to the specially illustrated embodiment variants of the same, but to the contrary diverse combinations of the individual embodiment variants with one another are also possible and, on the basis of the teaching of the technical handling by the subject invention, this variation possibility lies within the know-how of the person skilled in the art and active in this technical field.

The scope of protection is defined by the claims. However, the description and the drawings are to be used for interpretation of the claims. Individual features or combinations of features from the shown and described different exemplary embodiments may represent inventive solutions that are independent in themselves. The task underlying the independent inventive solutions may be inferred from the description.

All statements about value ranges in the description of the subject matter are to be understood to the effect that they jointly comprise any desired and all sub-ranges therefrom, e.g. the statement 1 to 10 is to be understood to the effect that all sub-ranges, starting from the lower limit 1 and the upper limit 10 are jointly comprised, i.e. all sub-ranges begin with a lower range of 1 or greater and end at an upper limit of 10 or smaller, e.g. 1 to 1.7, or 3.2 to 8.1, or 5.5 to 10.

Finally, it must be pointed out, as a matter of form, that some elements have been illustrated not to scale and/or enlarged and/or reduced for better understanding of the structure.

### LIST OF REFERENCE NUMERALS

1 Emergency vehicle
2 Vehicle body
3 Wheel pair
4 Front-wheel pair
5 Rear-wheel pair
6 Wheel
7 Secondary energy unit
8 Internal combustion engine
9 Generator
10 Primary energy unit
11 Electric motor
12 Electrical wiring network
13 Electronic control unit
14 Carrier frame
15 Lifting eye
16 Fastening means
17 Carrying strut
18 First shiftable clutch
19 Consuming unit
20 Gearbox
21 Angular gearbox
22 Second shiftable clutch
23 Freewheel
24 Drive shaft
25 Differential
26 Half axis
27 Gearbox
28 Second electric motor
29 Secondary output
30 Power take-off shaft
31 Energy input interface
32 Energy output interface

1. An emergency vehicle (1), especially a fire truck, comprising:
a vehicle body (2);
at least two wheel pairs (3) having respectively at least two wheels (6), which are disposed on the vehicle body (2);
a primary energy unit (10), especially an accumulator, for storage of electrical energy;
a secondary energy unit (7) for conversion of an energy stored in a fuel into electrical energy;
at least one electric motor (11),
wherein
the secondary energy unit (7) is disposed on at least one carrier frame (14), wherein the carrier frame (14) is received in modular and detachable manner on the vehicle body (2).

2. The emergency vehicle according to claim 1, wherein the secondary energy unit (7) is designed in the form of a galvanic cell.

3. The emergency vehicle according to claim 1, wherein the secondary energy unit (7) is designed in the form of an internal combustion machine, such as an internal combustion engine (8), wherein the internal combustion machine is coupled with a generator (9).

4. The emergency vehicle according to claim 3, wherein at least one consuming unit (19), especially an emergency machine such as a pump, is disposed on the emergency vehicle (1), which at least one consuming unit (19) is coupled mechanically with the secondary energy unit (7), optionally via interposition of a gearbox (20).

5. The emergency vehicle according to claim 3, wherein a first shiftable clutch (18) is interposed between the secondary energy unit (7) and the generator (9).

6. The emergency vehicle according to claim 4, wherein a second shiftable clutch (22) is interposed between the generator (9) and the at least one consuming unit (19), especially the pump.

7. The emergency vehicle according to claim 3, wherein the generator (9) can be used while the internal combustion engine (8) is stationary, optionally for operation as an electric motor and thus for the drive of the consuming unit (19), wherein the first shiftable clutch (18) is decoupled between the generator (9) and the internal combustion engine (8), or wherein a freewheel (23) is disposed between the generator (9) and the internal combustion engine (8).

8. The emergency vehicle according to claim 1, wherein the primary energy unit (10) and the secondary energy unit (7) are additively connectable by means of an electronic control unit (13), so that the power of the primary energy unit (10) and also the power of the secondary energy unit (7) can be fed simultaneously to the electric motor (11).

9. The emergency vehicle according to claim 1, wherein the at least one consuming unit (19), especially the pump, is likewise disposed on the carrier frame (14).

10. The emergency vehicle according to claim 9, wherein the secondary energy unit (7) is disposed close to the at least one consuming unit (19) on the carrier frame (44).

11. The emergency vehicle according to claim 10, wherein the secondary energy unit (7) and the at least one consuming unit (19) are coupled with one another by means of a gearbox (21).

12. The emergency vehicle according to claim 1, wherein the carrier frame (14) is disposed in the region of the rear wheel pair (3), above it.

13. The emergency vehicle according to claim 1, wherein the carrier frame (14) has a lifting eye (15), by means of which lifting eye (15) the carrier frame (14) can be lifted away from the vehicle body (2).

14. The emergency vehicle according to claim 1, wherein the electric motor (11) is designed as a drive motor for at least one of the wheels (6).

15. The emergency vehicle according to claim 1, wherein the wheels (6) at least of one of the wheel pairs (3) are coupled with one another by means of a differential (25) and in that the electric motor (11), as the central drive of the two wheels (6), is coupled with the differential (25).

16. The emergency vehicle according to claim 15, wherein the electric motor (11) is coupled by means of a gearbox (27) with the differential (25) and in that a secondary output (29) for the drive of further units is formed on the gearbox (27), wherein optionally the differential (25) and/or the secondary output (29) can be driven by the electric motor (11) by means of the gearbox (27).

17. The emergency vehicle according to claim 15, wherein a second electric motor (28) is coupled with the differential (25), wherein the second electric motor (28) cooperates in modular manner with the first electric motor (11).

18. The emergency vehicle according to claim 1, wherein an energy-input interface (31) is formed, by means of which electrical energy can be drawn from an external energy-supplying apparatus, such as, for example, a further emergency vehicle.

19. The emergency vehicle according to claim 1, wherein an energy-output interface (32) is formed, by means of which electrical energy can be delivered to an external energy-drawing source, such as, for example, a further emergency vehicle.

20. A method for operation of an emergency vehicle (1), especially an emergency vehicle (1) according to claim 1, wherein, in a power mode, the electrical energy generated by the secondary energy unit (7) and additively therewith the electrical energy stored in the accumulator (10) is used for the drive of the electric motor (11).
